(19) United States
(12) Patent Application Publication
(10) Pub. No.: US 2009/0035975 A1
(43) Pub. Date: Feb. 5, 2009

(54) CONNECTOR AND CONNECTOR TERMINAL CONSTRUCTION

(75) Inventor: Atsushi Arai, Toyama (JP)

Correspondence Address: DARBY & DARBY P.C., P.O. BOX 770, Church Street Station, New York, NY, 10008-0770, US

(73) Assignee: SMK Corporation, Tokyo (JP)

(21) Appl. No.: 12/099,817

(22) Filed: Apr. 9, 2008

(30) Foreign Application Priority Data
Aug. 3, 2007 (JP) 2007-203660

(51) Int. Cl. H01R 13/187

(52) U.S. Cl. 439/259

(57) ABSTRACT

A connector of the engagement connection type using a plug and socket includes at least a plug pin for the plug and a socket terminal for the socket on one side. A projection of at least one of the plug pin and socket terminal projects toward a connection surface of the other one of the plug pin and socket terminal. The projection is affixed to elastic contact arm that exerts an elastic force toward a contact surface of the other one of the plug pin and socket terminal.

### CROSS-REFERENCE TO RELATED APPLICATION

The present application claims priority from Japanese Patent Application No. 2007-203660, which was filed on Aug. 3, 2007, and is hereby incorporated by reference in its entirety herein.

### FIELD OF THE INVENTION

The present invention relates to a connector for making an electrical connection, particularly a connector of a plug and socket engagement type as well as a connector terminal construction for the same.

### BACKGROUND OF THE INVENTION

For example, as shown in FIG. 6(a), a connector for making an electrical connection has a plug pin 121 of a plug 120 that is inserted into a cylindrical socket terminal 111 of a socket 110 is public knowledge.

With this type of connector, it is easy to insert the plug pin, and for the sake of stabilizing the electrical connection, the socket terminal is of a so-called bottle-shaped configuration. Typically, a notch 115 is formed in the cylindrical part in the insertion direction, and an elastic contact arm 116 is formed with the end expanding in diameter on the outer side.

Accordingly, in order to ensure contact strength with the plug pin, there must be ample elastic displacement in the direction of the expanding diameter of the elastic contact arm 116, but since the end part 116b has an expanding diameter going toward the end, there is a need to have a large space 117 between this and the housing 130 that insulates the terminal. For this to be made possible, the plug housing must also be expanded, making compactness of the connector difficult.

In Published Unexamined Japanese Patent Application No. H10-116644, a technology is disclosed in which a protrusion provided within the socket terminal makes a point contact with the plug pin, but there is a large amount of dispersion with regard to the height of the protrusion, resulting in degradation of contact reliability.

### SUMMARY OF THE INVENTION

In light of the technological problems noted above, it is an object of the present invention to provide a contact terminal construction and a compact form of a connector based on this construction in which there is a high level of electrical connection reliability as well as effective compactness of the connector.

The present invention is a connector of the engagement connection type using a plug and socket, in which there is, at the least, a plug pin for the plug and a socket terminal for the socket on one side, as well as a projection that projects toward the connection surface of the other side along with an elastic contact arm with an elastic force toward this connection surface of the other side.

There are various types of plug pins used in plugs, including round plug pins with hemispherical end parts, as well as strip plugs and the like.

On the other hand, there are also various types of socket terminals used in sockets, including cylindrical terminals, side-snap types and the like.

The present invention has contact means through a projection on one side, between at least a plug pin of such a plug, or a socket terminal of such a socket, as well as contact means through an elastic arm.

The invention is suitable for use in a cylindrical socket terminal in which a plug pin is inserted, having a protrusion on the inside of the cylindrical part of the socket terminal in which the plug pin is inserted. Further, this socket terminal has an elastic contact arm with an elastic force toward the inside, in which one part of the cylindrical part is formed by cutting along the engagement direction of the plug pin.

In the present invention, since it is possible to make an electrical connection using two different types of contact means for the plug pins and socket terminals, namely, contact means through the use of a protrusion, and contact means through the use of an elastic arm, the amount of bending of the elastic arm via the contact means through the use of a protrusion can be held below that of a conventional bottle-shaped configuration, and moreover, the effects from contact dispersion due to the height dispersion of protrusions in the case of contact means through the use of an elastic arm can be reduced. Further, the reliability of the electrical connections is improved, and compared to the contacts in the conventional bottle-shaped configuration, the space between the housing and the end part of the socket terminal can be reduced, making it possible to provide compactness to the connector.

### BRIEF DESCRIPTION OF THE DRAWINGS

The invention will become more readily apparent from the Detailed Description on the Invention, which proceeds with reference to the drawings, in which

FIG. 1(a) shows a side view of the plug pin and socket terminal prior to electrical connection;

FIG. 1(b) shows a plan view of the plug pin and socket terminal;

FIG. 1(c) shows an explanatory drawing of the plan view of the socket part in the state in which a cut is made corresponding to view A-A;

FIG. 2(a) shows a side view of the plug pin and socket terminal after an electrical connection has been made;

FIG. 2(b) shows a plan view of the plug pin and socket terminal;

FIG. 2(c) shows an explanatory drawing of the plan view of the socket part in the state in which a cut is made corresponding to view A-A;

FIGS. 3(a) and 3(b) show the socket connector with the socket terminal installed in the socket housing, as well as the plug connector with the plug pin installed in the plug housing;

FIG. 4(a) through 4(c) show the plug part as it is inserted into the socket part;

FIG. 5 shows a plan view of the plug pin that is equipped with an elastic contact arm and contact protrusion; and

FIGS. 6(a) and 6(b) provide explanatory drawings of a conventional terminal connection construction.

### DETAILED DESCRIPTION OF THE INVENTION

The following listing provides a key to the reference numerals and elements depicted in the drawings.
1: Electric line
2: Core wire
10: Socket terminal
11: Socket part
12: Cylinder part
13: Insertion port
14: Contact protrusion
15: Slit part
16: Elastic contact arm
16a: Flexible arm
16b: Slanted arm
16c: Contact point
17: Lance
18: Stabilizer
19: Electric line connection part
20: Plug pin
21: Plug part
22: Plug front end part
23: Plug side surface part
24: Lance
25: Stabilizer
26: Electric line connection part
30: Socket housing
31: Cylindrical receiver part
32: Cylindrical insertion part
33: Terminal storage chamber
34: Inner wall of terminal storage chamber
35: Guide groove
36: Lance clip part
37: Cylindrical concave part
40: Plug housing
41: Cylindrical plug-in part
42: Cylindrical insertion part
43: Terminal storage chamber
44: Inner wall of terminal storage chamber
45: Guide groove
46: Lance clip part
50: Socket connector
60: Plug connector

The following examples are used to describe a connector according to the present invention which is composed of a round plug pin and a cylindrical socket terminal, and as for the construction of the connector related to the present invention, it is possible to apply this to various connector types in which an engagement connection is made between a plug pin and socket terminal.

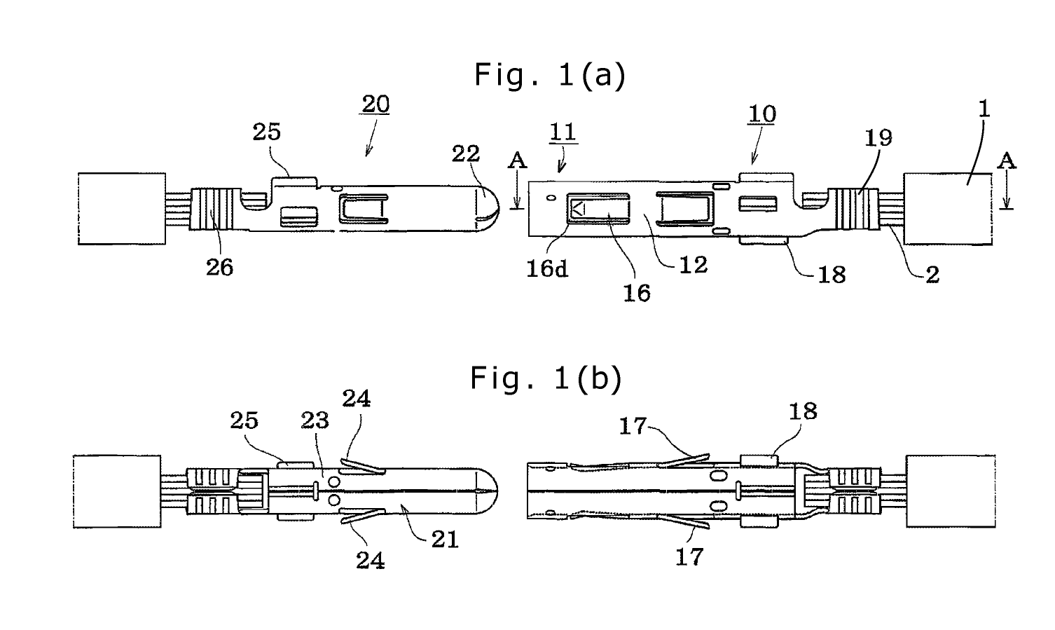

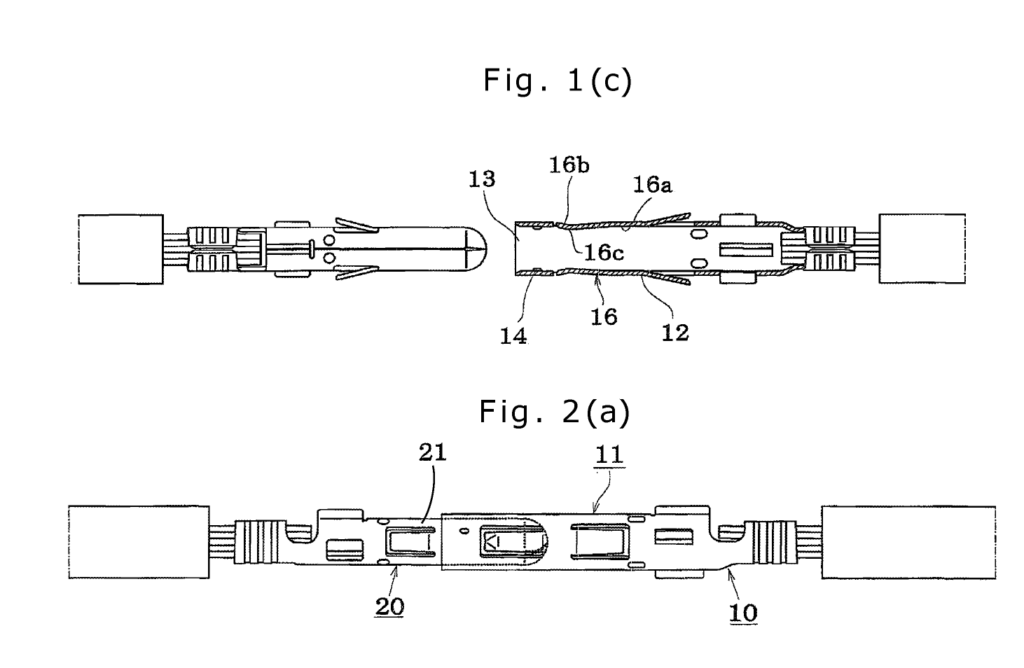

FIG. 1(a) is a side view of a plug pin 20 and socket terminal 10 prior to the engagement connection, and FIG. 1(b) is a plan view of the same. FIG. 1(c) is a plan view of a cutaway corresponding to view A-A of a socket part 11 of the socket terminal 10.

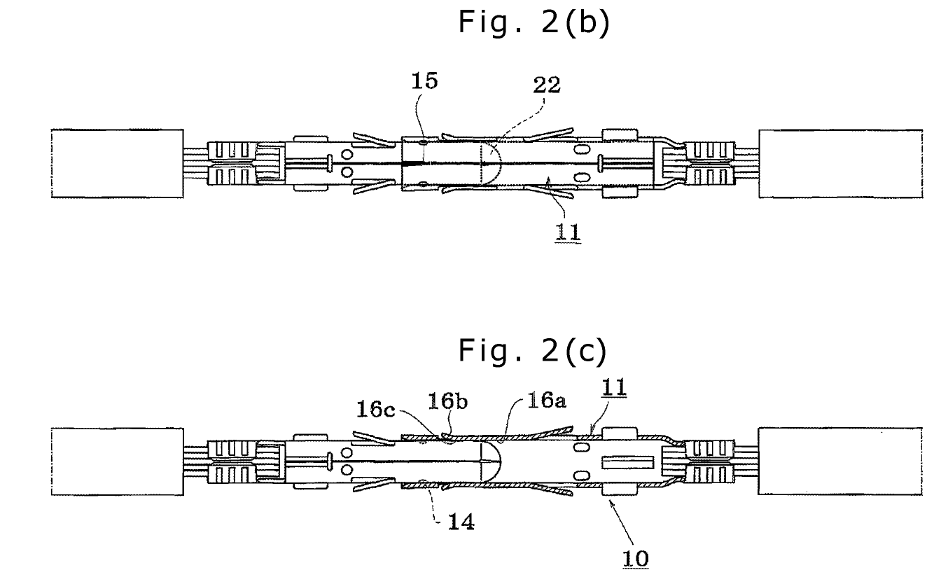

FIG. 2(a) is a side view of the plug pin 20 and socket terminal 10 after the engagement connection, and FIG. 2(b) is a plan view of the same. FIG. 1(c) is a plan view of a cutaway corresponding to view A-A of the socket part of the socket terminal 10 in its engaged state.

The socket terminal 10 is provided with an insertion port 13 for inserting the plug part 21 of the plug pin 20 into the end in the direction of engagement of the cylindrical socket part 11, and the rear end of this socket terminal 10 has an electric line connection part 19.

The plug pin 20 has a hemispherical end part 22 of the pin-shaped plug part 21, and the rear end has an electric line connection part 26.

An electric line 1 and core wire 2 are connected in a crimped fashion to the respective electric line connection parts 19 and 26.

A cut is made in the socket terminal 10 from the cylinder part 12 in which the side wall of the engagement part of the socket 11 is formed, and a bent tongue-shaped lance 17 is provided to broaden the end part on the outer side in the direction of the side of the electric line connection part, while a stabilizer 18 is erected toward the outside from the cylinder part 12.

The plug pin 20 is equipped with a lance 24 that is cut from a plug side surface part 23 and is set at an angle in order to expand the rear end on the outer side, while a stabilizer 25 is erected toward the outside from the plug side surface part 23.

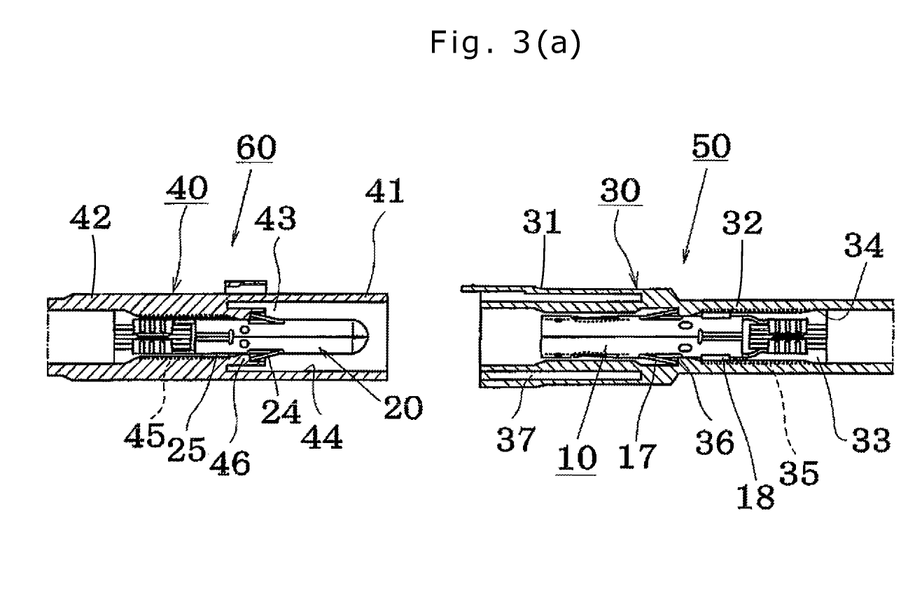

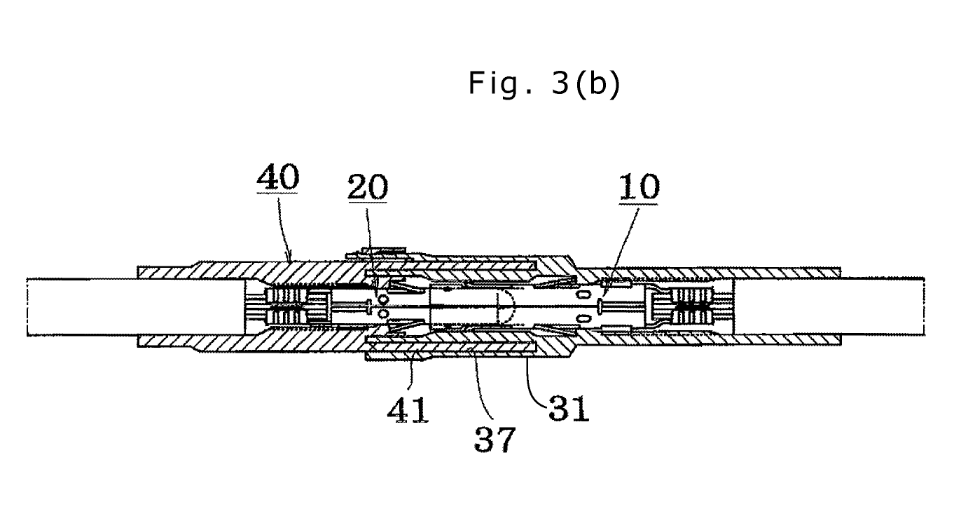

FIG. 3 shows a socket connector in which the socket terminal 10 is installed onto the socket housing 30 and held with a lance clip, along with a plug connector 60 in which a plug pin 20 is installed onto the plug housing 40 and held with a lance clip.

Sectional views in the horizontal direction of the respective housings are drawn, with FIG. 3(a) showing the housings prior to engagement and FIG. 3(b) showing them in an engaged state.

A socket housing 30 is in the form of a cylinder that has been fabricated with an insulating resin, and it is equipped with a cylindrical receiver part 31 on the front side in the engagement direction, a cylindrical insertion part 32 on the rear side, and a terminal storage chamber 33 in the center of the cylinder. Along an inner wall 34 of the terminal storage chamber are a guide groove 35 and lance clip part 36.

Within the terminal storage chamber 33, the socket terminal 10 is inserted along the stabilizer 18 in the guide groove 35 from the side of the cylindrical insertion part 32, and once it is in position the lance 17 snaps into place on the lance clip part 36.

As is shown in FIG. 3(b), the cylindrical receiver part 31 of the socket housing 30 is equipped with a cylindrical concave part 37 into which a cylindrical plug-in part 41 of the plug housing 40 is inserted and engaged.

The plug housing 40 is cylindrical and has the cylindrical plug-in part 41 on the front side in the engagement direction as well as a cylindrical insertion part 42 on the rear side. The center of the cylinder is equipped with a terminal storage chamber 43, and along an inner wall 44 of the terminal storage chamber are a guide groove 45 and lance clip part 46.

Within the terminal storage chamber 43, the plug pin 20 is inserted along the stabilizer 25 in the guide groove 45 from the side of the cylindrical insertion part 42, and once it is in position the lance 24 snaps into place on the lance clip part 46.

In this manner, the socket terminal 10 has the same installation configuration as the general configuration of the plug pin 20 and is installed within the socket housing 30.

As shown in FIG. 3(b), a socket connector 50 and plug connector 60 are designed such that the cylindrical plug-in part 41 of the plug housing 40 is inserted into the cylindrical concave part 37 of the socket housing 30 to form an engagement in which the socket terminal 10 makes an electrical connection with the plug pin 20.

As shown in FIG. 1, in the socket part 11 of the socket terminal, a contact protrusion 14 that protrudes toward the inside from the cylinder part 12 via the front end part in the engagement direction is formed, along with an elastic contact arm 16 that extends inward from the cylinder part 12 in the vicinity of the center space part in the engagement direction.

The elastic contact arm 16 is fabricated by forming a U-shaped notch part 16d in the cylinder part 12.

The contact protrusion 14 is formed through an embossing process of the cylinder part 12 from the outer side toward the inside.

The elastic contact arm 16 is bent inward from the cylinder part 12 and has a flexible arm 16a with an elastic force toward the connection surface with the plug when contact is made with the plug pin, along with a slanted arm 16b that bends back toward the outside from the front end of the flexible arm 16a. The apex point in the bent back area of the slanted arm 16b and flexible arm 16a forms the contact point 16c.

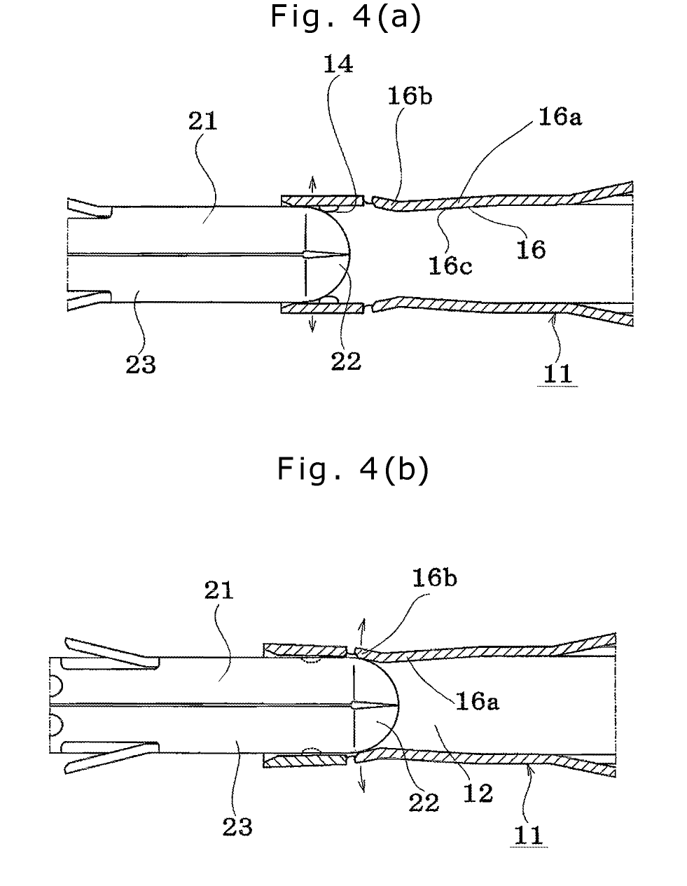

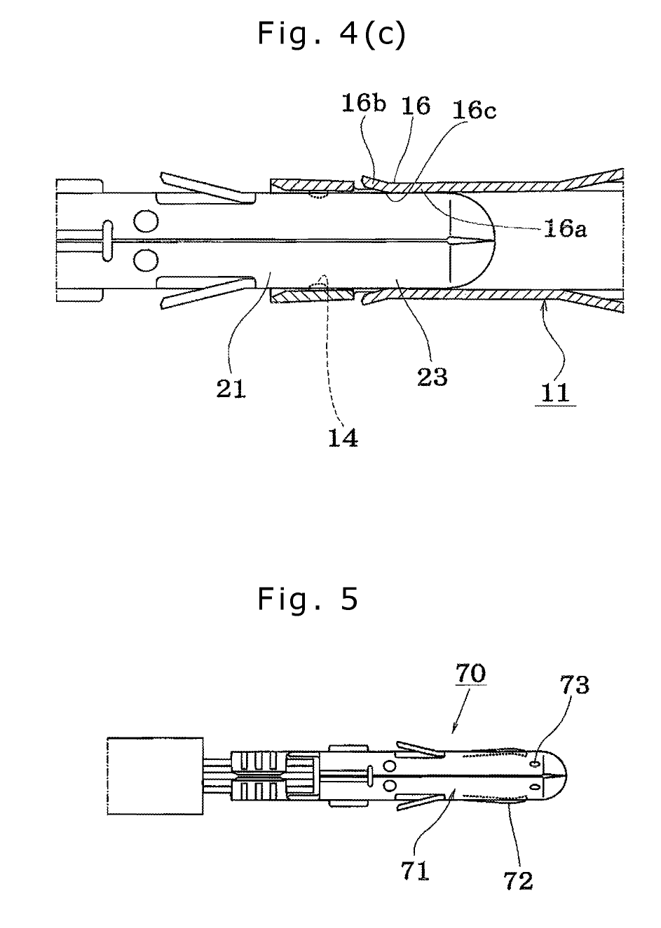

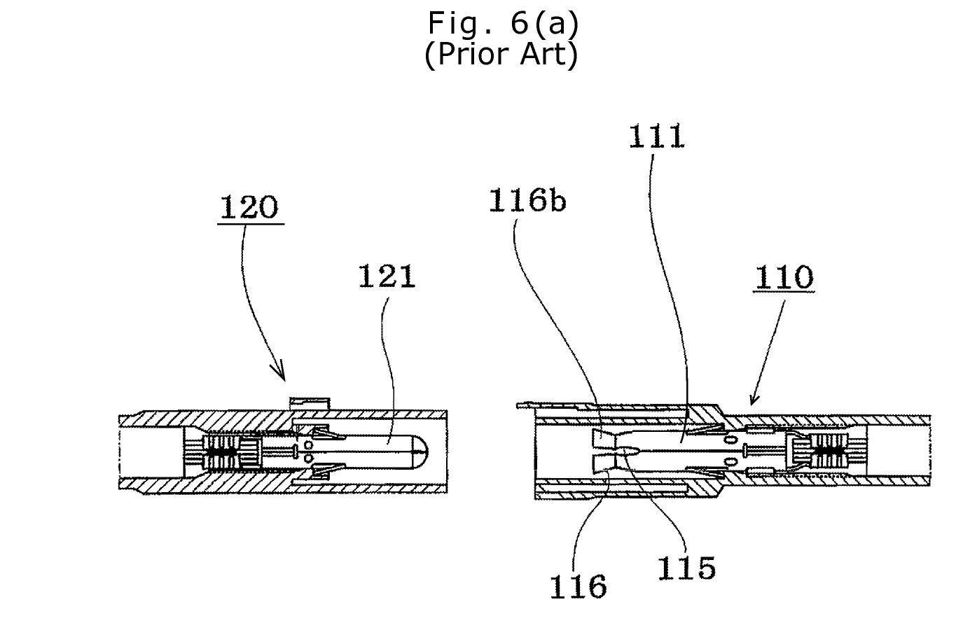

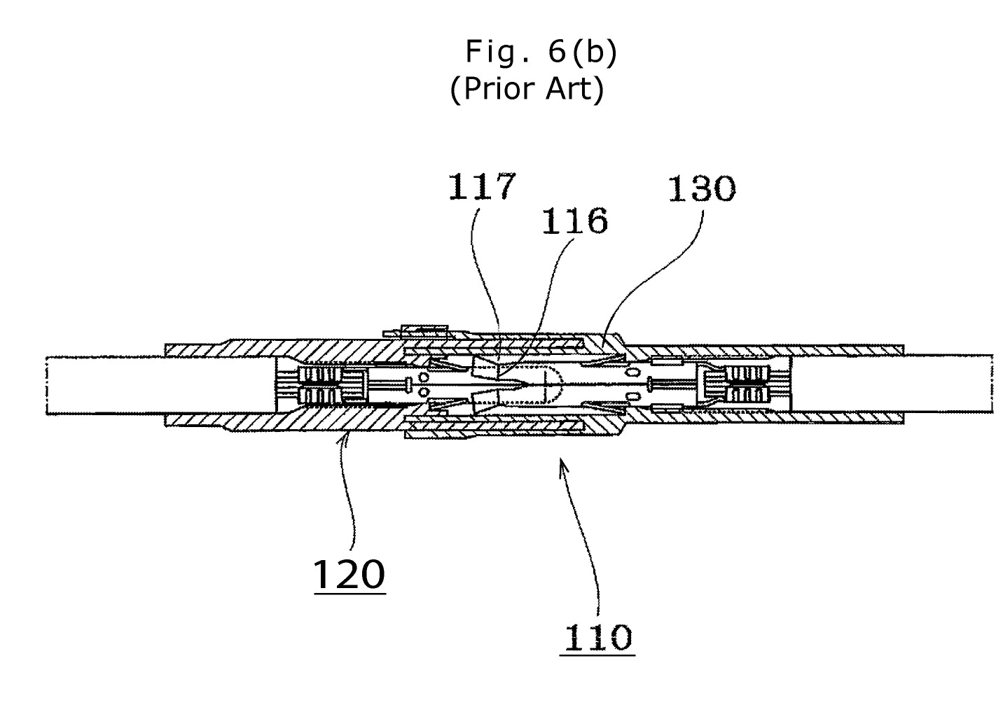

FIG. 4 is an expanded explanatory diagram that illustrates the condition at the point where the plug part 21 is inserted into the socket part 11.

With the insertion of the plug part 21, the plug front end part 22 strikes against the contact protrusion 14 as shown in FIG. 4(a).

Then, when the plug part 21 is inserted as is, the contact protrusion 14 is guided by the hemispherical tilting of the plug front end part 22, such that it is lifted over the plug side surface part 23 and makes an electrical connection as shown in FIG. 4(b).

At this point, since the socket part 11 has a slit part 15 that has been formed along the insertion direction as shown in FIG. 2(b), this slit part 15 widens to expand in diameter, and the plug part 21 can be inserted into the socket part 11 without collapsing the contact protrusion 14.

Further, when the plug part 21 is inserted, the plug front end part 22 slides into contact with the slanted arm 16b of the elastic contact arm 16, and the flexible arm 16a bends toward the outer side while it is lifted to the plug side surface part 23.

Accordingly, an electrical connection is made when the contact point 16c is elastically connected to the plug side surface part 23 through the elastic restoration force of the flexible arm 16a as shown in FIG. 4(c).

It is acceptable for the elastic contact arm 16 to make an electrical connection through elastic contact while the flexible arm is allowed to bend in the plug part 21 that has been inserted into the socket part 11 in the fashion described above. Further, it is acceptable for the direction of the cut to be contrary to that described in this embodiment, that is, toward the rear.

FIG. 5 shows an embodiment of a plug pin 70 in which the plug part 71 is equipped with an elastic contact arm 72 and contact protrusion 73, and it is acceptable to make an electrical connection between the elastic contact arm 72 and the contact protrusion 73 on the inside surface of the socket terminal through engagement of the plug part 71 in the socket terminal.

It is within the scope of the present invention to include all foreseeable equivalents to the elements of the present invention as described with relevance to FIGS. 1(a)-5. The examples provided by the disclosure are not to be interpreted as limiting the invention beyond that which is claimed.

1. A connector of the engagement connection type using a plug and socket, comprising:
at least one plug pin for the plug;
at least one socket terminal for the socket; and
a projection that projects toward a contact surface between the plug pin and at least one socket terminal comprising an elastic contact arm providing an elastic force against the contact surface.

2. A contact terminal construction with a cylindrical socket terminal in which a plug pin is engaged, having a protrusion protruding into an interior portion of the cylindrical socket terminal in which the plug pin is inserted, the protrusions protruding from at least one elastic contact arm exerting an elastic force toward the interior portion wherein the elastic contact arm cylindrical socket terminal is formed by cutting along an engagement direction of the plug pin.

3. The contact terminal construction of claim 2, wherein the elastic contact arm comprises a u-shaped notch part formed by cutting along the engagement direction of the plug pin.

4. The contact terminal construction of claim 3, wherein a distal free end of the notch part comprises a slanted tip, the slanted tip meeting a bent portion of the elastic contact arm to define a contact point of the protrusion.
